(19) United States
(12) Patent Application Publication
(10) Pub. No.: US 2019/0186618 A1
(43) Pub. Date: Jun. 20, 2019

(54) AUTOMATED MECHANICAL TRANSMISSION AND SYSTEM FOR MEDIUM-DUTY COMMERCIAL ELECTRIC VEHICLES

(71) Applicant: Eaton Intelligent Power Limited, Dublin (IE)

(72) Inventors: Kevin Eric Portella, Royal Oak, MI (US); Gregory Ernest Papp, Brownstown, MI (US); Thomas Alan Genise, Dearborn, MI (US)

(73) Assignee: Eaton Intelligent Power Limited, Dublin (IE)

(21) Appl. No.: 16/285,859

(22) Filed: Feb. 26, 2019

Related U.S. Application Data
(63) Continuation of application No. PCT/US2017/048897, filed on Aug. 28, 2017.
(60) Provisional application No. 62/379,804, filed on Aug. 26, 2016.

(51) Int. Cl. F16H 57/033; B60K 1/00; B60K 17/06; F16H 57/031

(52) U.S. Cl. CPC F16H 57/033; B60K 1/00; B60K 17/06; F16H 57/031; F16H 2057/0206; B60Y 2200/91; B60Y 2200/92; F16H 2057/0335; B60Y 2200/141

(57) ABSTRACT

A modular transmission system selectively coupled to an electric motor arranged on a vehicle according to a first example of the present disclosure includes a front housing, a first rear housing and a second rear housing. The front housing has a transmission motor mount and at least one transmission chassis mount. The transmission motor mount is configured to mount the front housing relative to the electric motor. The first rear housing has a first gear set. The first rear housing is configured to selectively couple to the front housing to provide first gear ratios in the first modular transmission configuration. The second rear housing has a second gear set. The second rear housing is configured to selectively couple to the front housing to provide second gear ratios in the second modular transmission configuration.

### CROSS-REFERENCE TO RELATED APPLICATIONS

This application is a continuation of International Application No. PCT/US2017/048897 filed Aug. 28, 2017, which claims priority to U.S. Provisional Application No. 62/379,804 filed on Aug. 26, 2016. The disclosure of the above application is incorporated herein by reference.

### FIELD

The present disclosure relates generally to an automated mechanical transmission (AMT) system for medium-duty commercial electric and hybrid vehicles.

### BACKGROUND

Automated mechanical transmission (AMT) systems for vehicle use are known in art. As is well known, an AMT includes a clutch and a collection of gears. The AMT performs gear shifts automatically. AMTs can be provided on many vehicles including line haul vehicles and large construction vehicles. Fuel economy regulations are driving the need for greater fuel efficiency in both line haul and vocational vehicles. Commercial electric vehicles (CEV) and hybrid vehicles eliminate or reduce fuel consumption and can be preferred in some applications.

Commercial vehicle transmissions typically have too many gear ratios suitable for application with CEV's. Electric traction motors for CEV's generally have very different power and torque characteristics as a function of motor speed. This demands a different configuration of transmission having fewer gears, with gear ratios that are numerically farther apart from each other. Furthermore, light-duty and medium-duty CEV's often do not have compressed air on board. In this regard, transmission design cannot rely on compressed air to supply actuation input for the transmission. It would be desirable to provide an AMT system suitable for use with an electric motor and that can easily adapt for a wide range of application and gearing requirements.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A modular transmission system selectively coupled to an electric motor arranged on a vehicle according to a first example of the present disclosure includes a common front housing, a first rear housing and a second, or alternate, rear housing. The front housing has a transmission motor mount and at least one transmission chassis mount. The transmission motor mount is configured to mount the front housing relative to the electric motor. The at least one transmission chassis mount is configured to mount the front housing relative to a chassis of the vehicle. The first rear housing has a first gear set, or first set of gear ratios. The first rear housing is configured to selectively couple to the front housing to accommodate the first set of gear ratios in the first modular transmission configuration. The second rear housing has a second gear set. The second rear housing is configured to selectively couple to the front housing to accommodate the second set of gear ratios in the second, or alternate, modular transmission configuration. The front housing is configured to selectively and alternatively accept (i) the first rear housing and first gearset for operation in a first modular transmission configuration and (ii) the second rear housing and second gear set for operation in a second modular transmission configuration.

According to additional features, the first set is configured as a four speed with no reverse gear and has a Y-Y shifting mechanism—with the “Y-Y” designation meaning both shifters actuate in the same axial direction. In another arrangement, the first gear set is configured as a three speed with no reverse gear and has a Y-Y shifting mechanism. The second gear set is configured as a four speed with reverse gear and has an X-Y shifting mechanism. In another arrangement, the second gear set is configured as a three speed with reverse gear and has a Y-Y shifting mechanism. An adapter plate can mount between the electric motor and the front housing. The front housing can include a transmission mounting plate configured to selectively mate with the electric motor in a first arrangement and the adapter plate in a second arrangement.

The first gear set includes a first input gear, a first mainshaft and a first countershaft. The first mainshaft supports a mainshaft first gear, a mainshaft second gear and a mainshaft third gear. The first countershaft supports a countershaft input gear, a countershaft second gear and a countershaft third gear. The second gear set includes a second input gear, a second mainshaft and a second countershaft. The second mainshaft supports a mainshaft first gear, a mainshaft second gear, a mainshaft third gear and a mainshaft reverse gear. The second countershaft defines reverse gear teeth and supports a countershaft input gear, a countershaft second gear and a countershaft third gear.

In additional features, the Y-Y shifting mechanism include a motor assembly including a first motor and a second motor configured to provide a shift input for a shift assembly having a first/second sliding clutch and a third/fourth sliding clutch. The shifting mechanism further comprises a first/second shift yoke that actuates the first/second sliding clutch and a third/fourth shift yoke that actuates the third/fourth shift yoke. The modular transmission system is configured as a wet sump. A cover plate can be removable coupled to the rear housing. The cover plate is configured to be removed to access the first countershaft to provide a rotatable input for a power take-off device.

In other features, the front housing includes a front housing flange configured to selectively and alternatively align with (i) a first complementary flange on the first rear housing in the first modular transmission configuration and (ii) a second complementary flange on the second rear housing in the second modular transmission configuration. Fasteners can locate through passages defined through the respective front housing flange and (i) first complementary flange in the first modular transmission configuration and (ii) second complementary flange in the second modular transmission configuration.

### BRIEF DESCRIPTION OF THE DRAWINGS

The present disclosure will become more fully understood from the detailed description and the accompanying drawings, wherein:

FIG. 1A is a schematic illustration of a modular transmission system assembly constructed in accordance to one example of the present disclosure and shown having a modular transmission system coupled to an exemplary electric motor, the modular transmission system having a front housing, a first gear set and first rear housing according to a first configuration;

FIG. 1B is a schematic illustration of the modular transmission system of FIG. 1 and shown having the front housing, a second gear set and a second rear housing according to a second configuration;

FIG. 2 is a rear perspective view of the modular transmission system of FIG. 1A;

FIG. 3 is a front perspective view of the modular transmission system of FIG. 2;

FIG. 4 is a partial cross-sectional view taken along lines 4-4 of the modular transmission system of FIG. 2;

FIG. 5A is a schematic illustration of the modular transmission system of FIG. 1 and shown highlighting a first gear torque path;

FIG. 5B is a schematic illustration of the modular transmission system of FIG. 5A and shown highlighting a second gear torque path;

FIG. 5C is a schematic illustration of the modular transmission system of FIG. 5A and shown highlighting a third gear torque path;

FIG. 5D is a schematic illustration of the modular transmission system of FIG. 5A and shown highlighting a fourth gear torque path;

FIG. 6 is a rear perspective view of the modular transmission system of FIG. 1B;

FIG. 7 is a front perspective view of the modular transmission system of FIG. 6; and

FIG. 8 is a partial cross-sectional view taken along lines 8-8 of the modular transmission system of FIG. 6.

### DETAILED DESCRIPTION

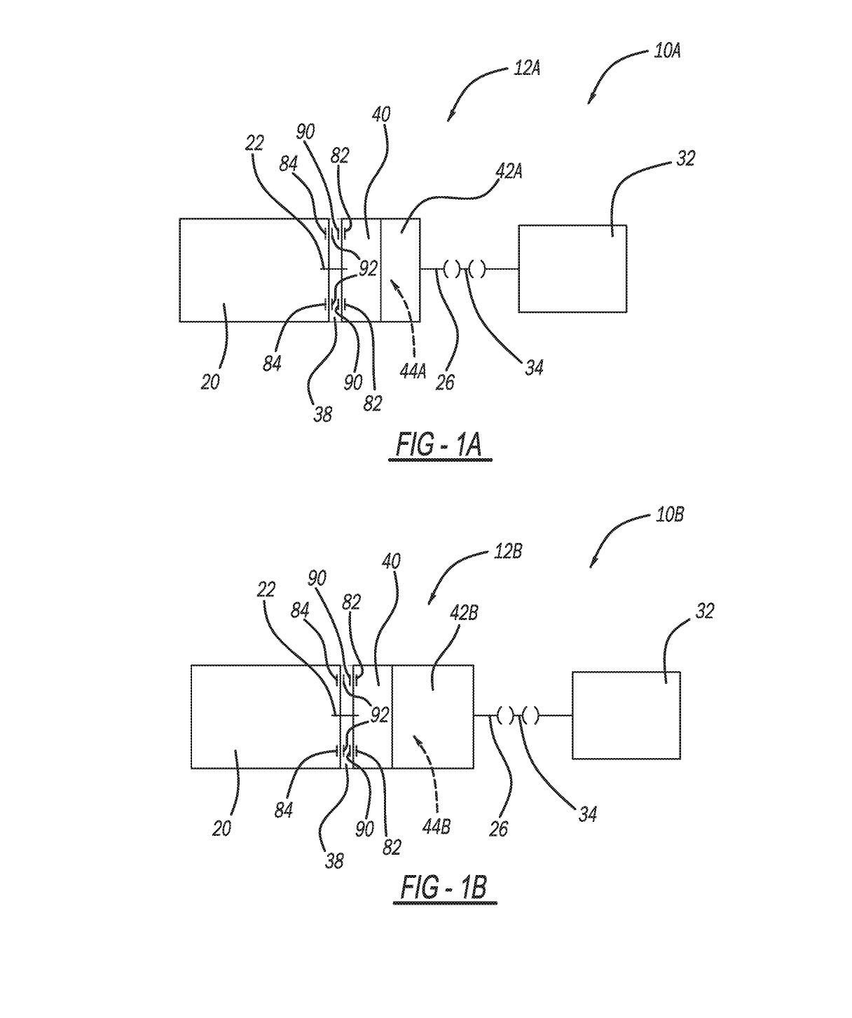

With initial reference to FIG. 1, a modular transmission system assembly constructed in accordance to one example of the present disclosure is shown and generally referred to at reference 10A. The modular transmission system assembly 10A includes a modular transmission system 12A that is driven by an electric motor 20. The modular transmission system assembly 10A can be used in vehicles incorporating an electric motor such as, but not limited to fully electric vehicle and hybrid electric vehicles. In the example shown, the modular transmission system 12A has a transmission input shaft 22 that is driven by the electric motor 20 and a transmission output shaft 26 that extends outwardly from the modular transmission system 12A. The output shaft 26 is ultimately drivingly connected with vehicle drive axles 32, usually by means of a prop shaft 34. In some examples, a master clutch may be interposed between the electric motor 20 and the transmission input shaft 22. An optional adapter plate 38 can be arranged between the electric motor 20 and the modular transmission system 12A to allow for suitable mounting points between the electric motor 20 and the adapter plate 38 as well as between the modular transmission system 12A and the adapter plate 38.

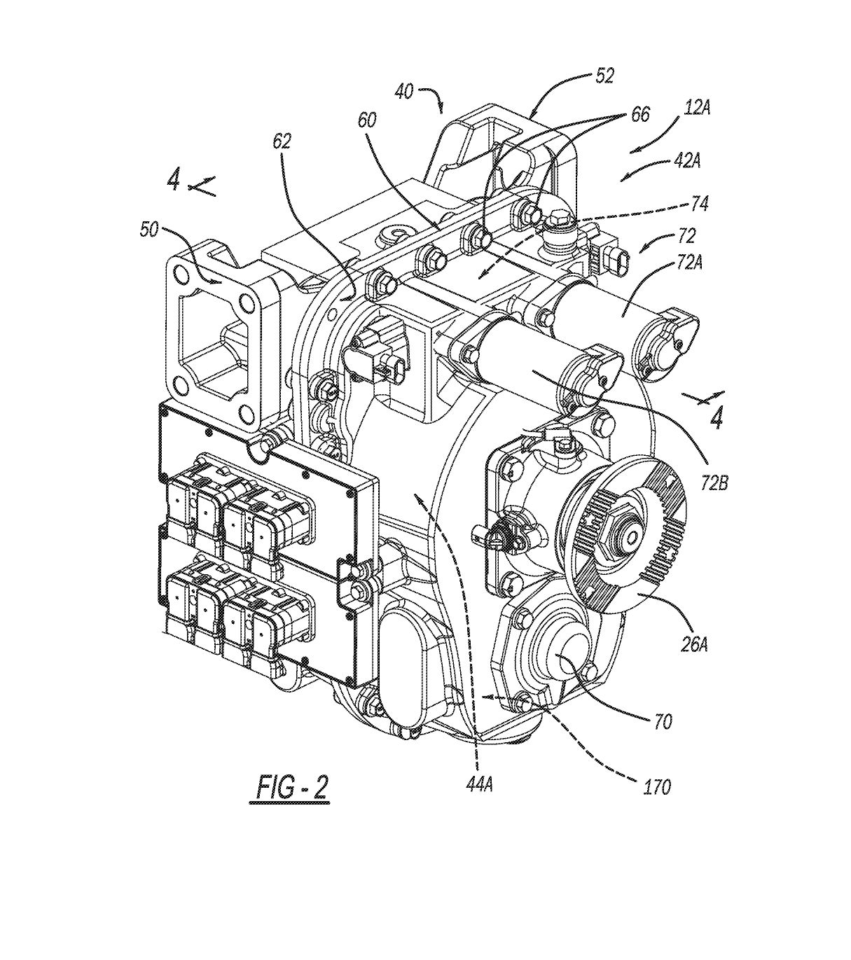

As will become appreciated from the following discussion, the modular transmission system 12A includes a split housing design in which a front housing 40 remains common for a plurality of possible electric vehicle AMT configurations whereas a rear housing 42A (FIG. 1A) and 42B (FIG. 1B), having unique gear sets, can be selected depending upon a particular application such as to accommodate various vocational needs. In this regard, the rear housing 42A can be used that may accommodate a first gear set 44A. Similarly, the rear housing 42B can be used that may accommodate a second gear set 44B. A modular transmission system assembly 10B, shown in FIG. 2 includes a modular transmission system 12B driven by the electric motor 20. The remaining components of the modular transmission system assembly 10B can be similar to those described above with respect to the modular transmission system assembly 10A.

While the following discussion is directed to two particular gear sets, the design is not so limited. Explained further, the modular transmission system 12A can accommodate a wide range of gear sets to accommodate a particular vehicle application. The front housing 40 together with an application specific rear housing (such as 42A, 42B) can accept larger or smaller gears, gear sets without reverse gear and with reverse gear (such as 44A and 44B, respectively) with minimal to no design change, effectively changing the overall gear ratios. It is contemplated that the only component which requires redesign for different gear sets is the countershaft (explained below) since the first gear is defined therein. The possible gear ratios can range anywhere between 9:1 to direct drive (Max Torque: 900 Nm) and 4:1 to direct drive (Max Torque: 1330 Nm).

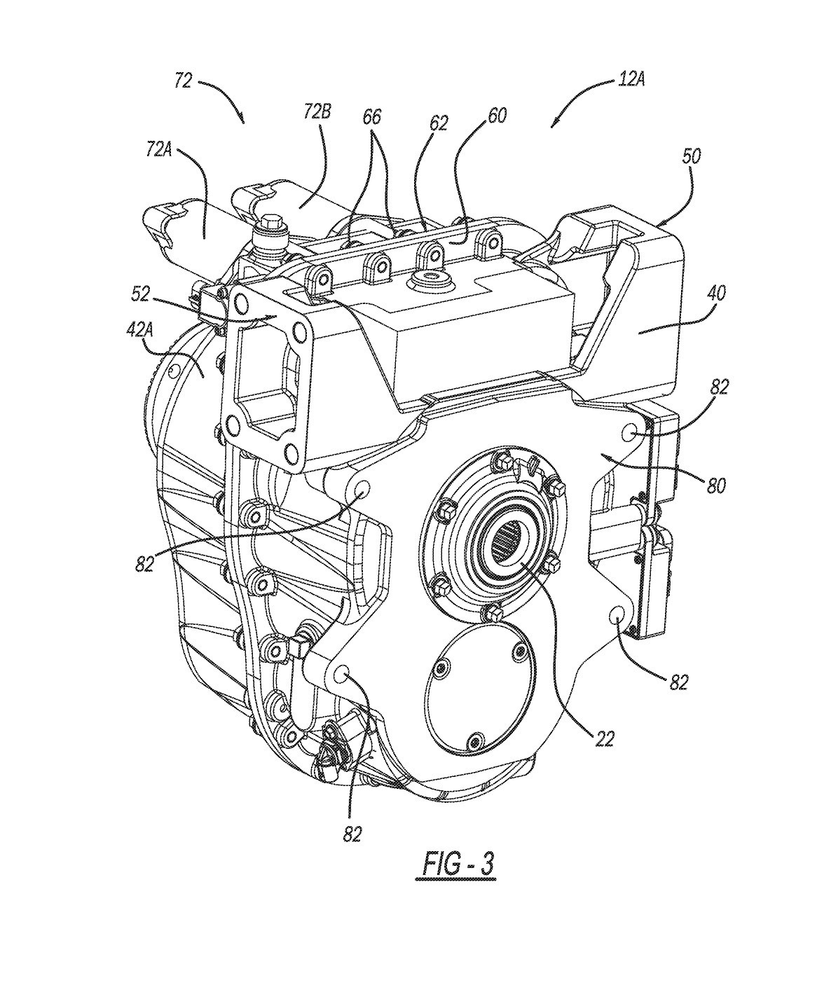

With particular reference now to FIGS. 2-4, the modular transmission system 12A will be described in greater detail. The front housing 40 includes transmission chassis mounts 50 and 52. In the example shown, the transmission chassis mounts 50 and 52 are standard SAE housing nodal mounts for flexible chassis to transmission integration. In some arrangements an elastomeric member (not shown) can be interposed between the chassis mounts 50, 52 and the frame rails of the chassis. The front housing 40 can include a front housing flange 60 configured to align with a complementary flange 62 provided on the rear housing 42A. Fasteners 66 can extend through passages defined through the respective flanges 60, 62 to couple the front housing 40 to the rear housing 42A. A cover plate 70 is removably coupled to the rear housing 42A. As will become appreciated, the cover plate 70 can be removed to access a countershaft for optionally providing a rotatable input for a power take off (PTO) device (such as an actuation mechanism for a refuse truck).

A motor assembly 72 includes a first motor 72A and a second motor 72B that are arranged in a Y-Y configuration and provide a shift input for a shift assembly 74. The front housing 40 defines a transmission mounting plate 80 having a plurality of transmission mounting points 82. In some examples, the transmission mounting points 82 can align with complementary motor mounting points 84 defined on the electric motor 20 for receiving fasteners that couple the front housing 40 and therefore the modular transmission 12A to the electric motor 20. In other examples, the adapter plate 38 can have a first set of mounting points 90 and a second set of mounting points 92. The first set of mounting points 90 align with the transmission mounting points 82 for receiving fasteners that couple the front housing 40 to the adapter plate 38. The second set of mounting points 92 align with the motor mounting points 82 for receiving fasteners that couple the adapter plate 38 to the electric motor 20. It will be appreciated that other mounting arrangements may be incorporated for coupling the front housing 40 with the electric motor 20 within the scope of the present disclosure.

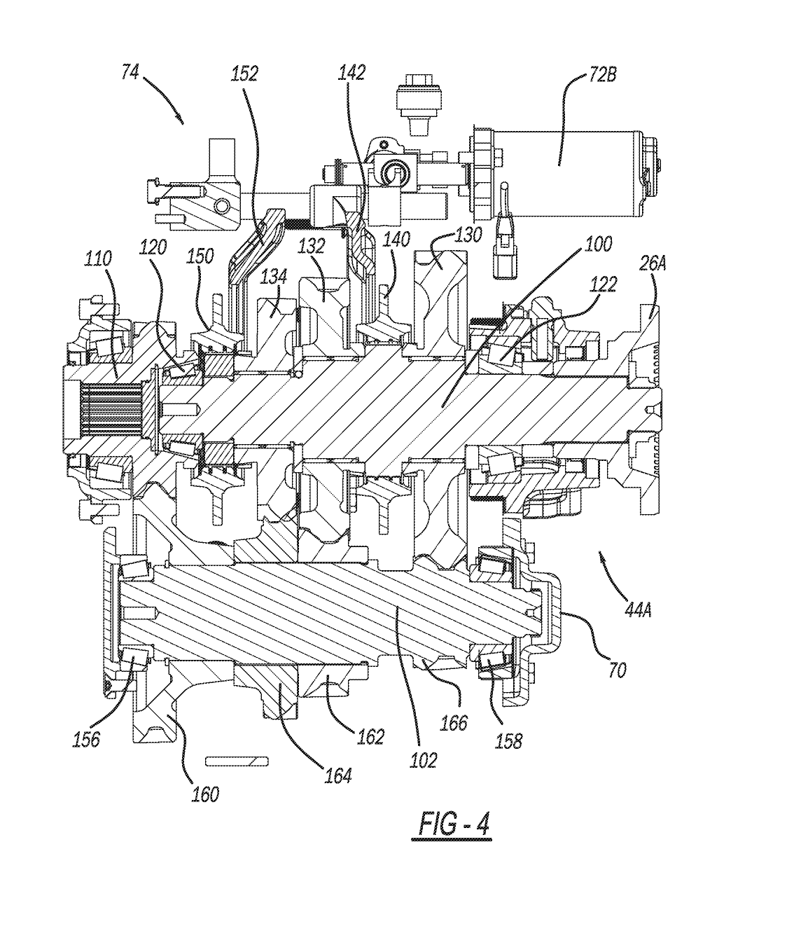

With reference now to FIG. 4, a first gear set 44A associated with the rear housing 42A of the modular transmission system 12A will be described. The first gear set 44A include a mainshaft 100 and a countershaft 102. In the example shown, the mainshaft 100 is coaxial with the transmission input shaft 22. The countershaft 102 is offset from the input shaft 22 and the mainshaft 100. The output shaft 26 may be coaxial with the mainshaft 100. The transmission input shaft 22 can be splined for rotation with an input gear 110.

The mainshaft 100 is supported in the modular transmission system 12A by a front mainshaft bearing 120 and a rear mainshaft bearing 122. The mainshaft 100 rotatably supports a mainshaft first gear 130, a mainshaft second gear 132, and a mainshaft third gear 134. A first/second sliding clutch 140 is actuated by a first/second shift yoke 142. A third/fourth sliding clutch 150 is actuated by a third/fourth shift yoke 152. The countershaft 102 is supported in the modular transmission system 12A by a front countershaft bearing 156 and a rear countershaft bearing 158. The countershaft 102 rotatably supports a countershaft input gear 160, a countershaft second gear 162 and a countershaft third gear 164. Countershaft first gear teeth 166 are defined on the countershaft 102 for meshingly engaging the mainshaft first gear 130. A wet sump 170 can be provided in the modular transmission 12A having adaptable oil level.

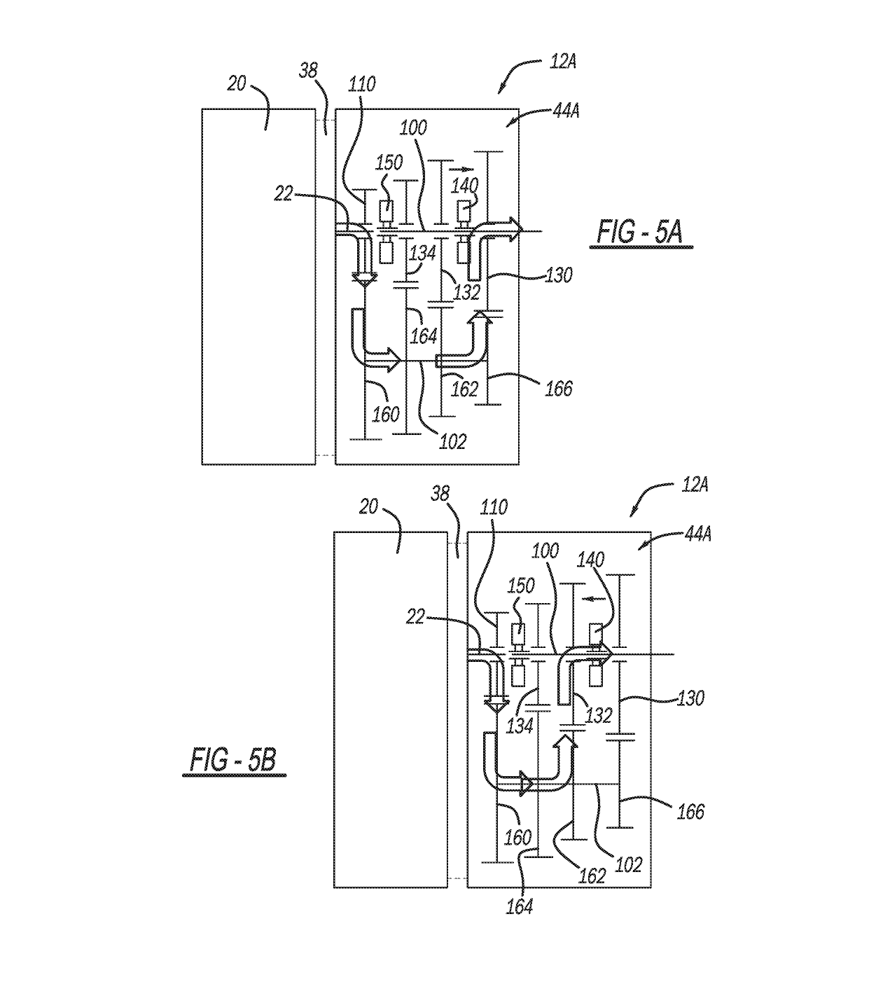

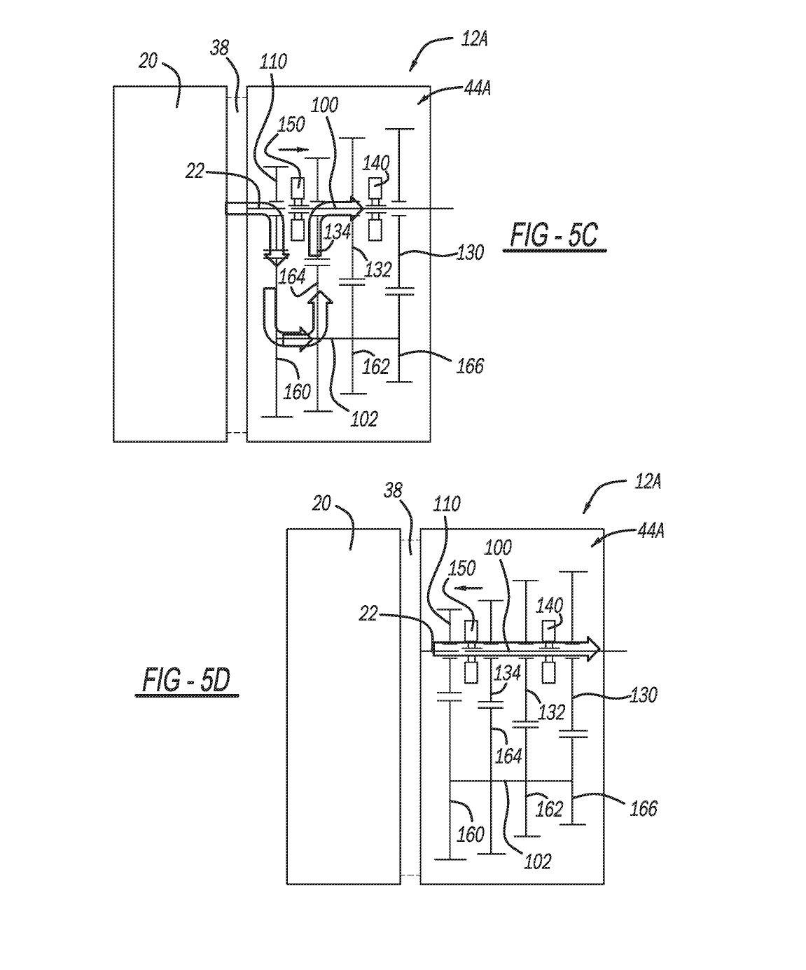

FIGS. 5A-5D illustrate the modular transmission system 12A configured for four speeds. In this regard, various torque paths are achieved for first, second, third and fourth gear speeds based on the positioning of the first/second sliding clutch 140 and the third/fourth sliding clutch 150. FIG. 5A shows the first gear set 44A in a first gear power path. FIG. 5B shows the first gear set 44A in a second gear power path. FIG. 5C shows the first gear set 44A in a third gear power path. FIG. 5D shows the first gear set 44A in a fourth gear power path, also known in the art as direct-drive with a ratio of 1:1. It is appreciated that the first gear set 44A can also be configured for operation in less than four speeds.

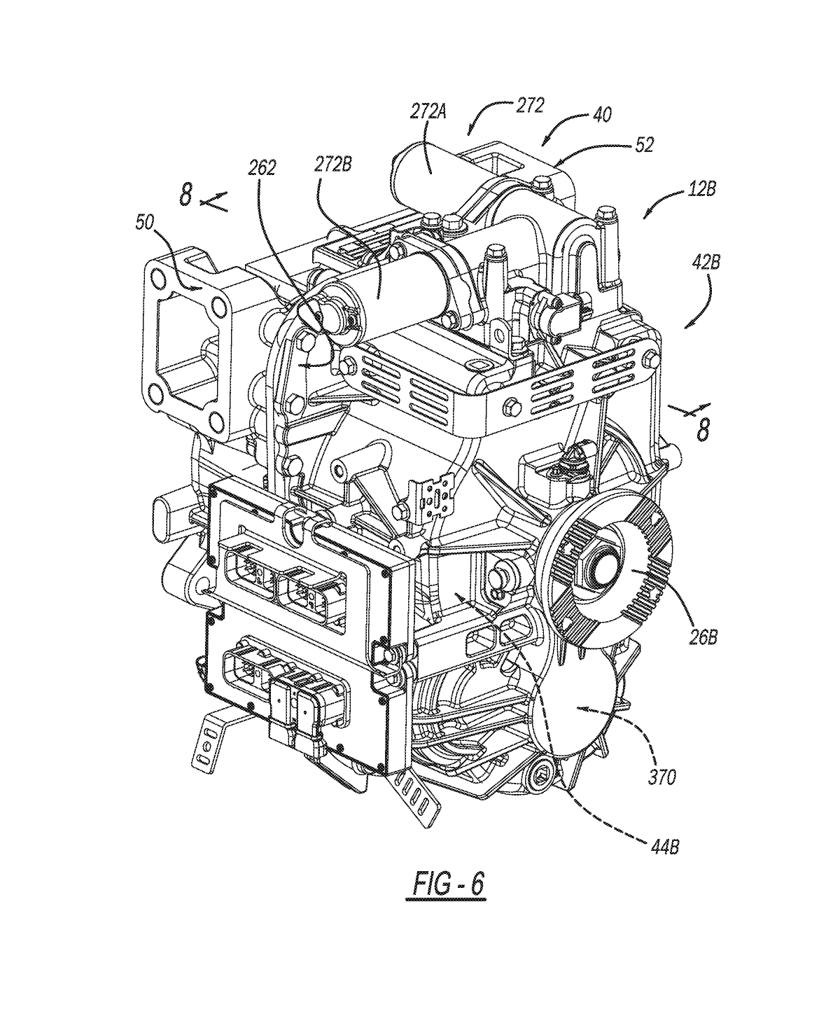

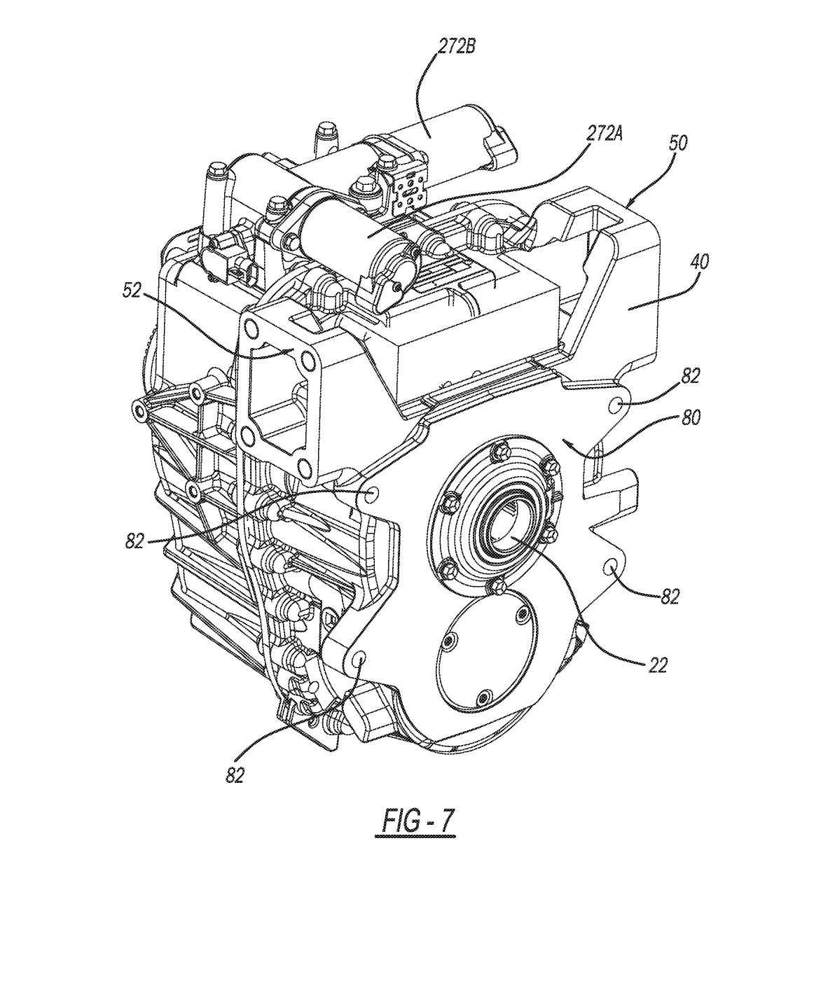

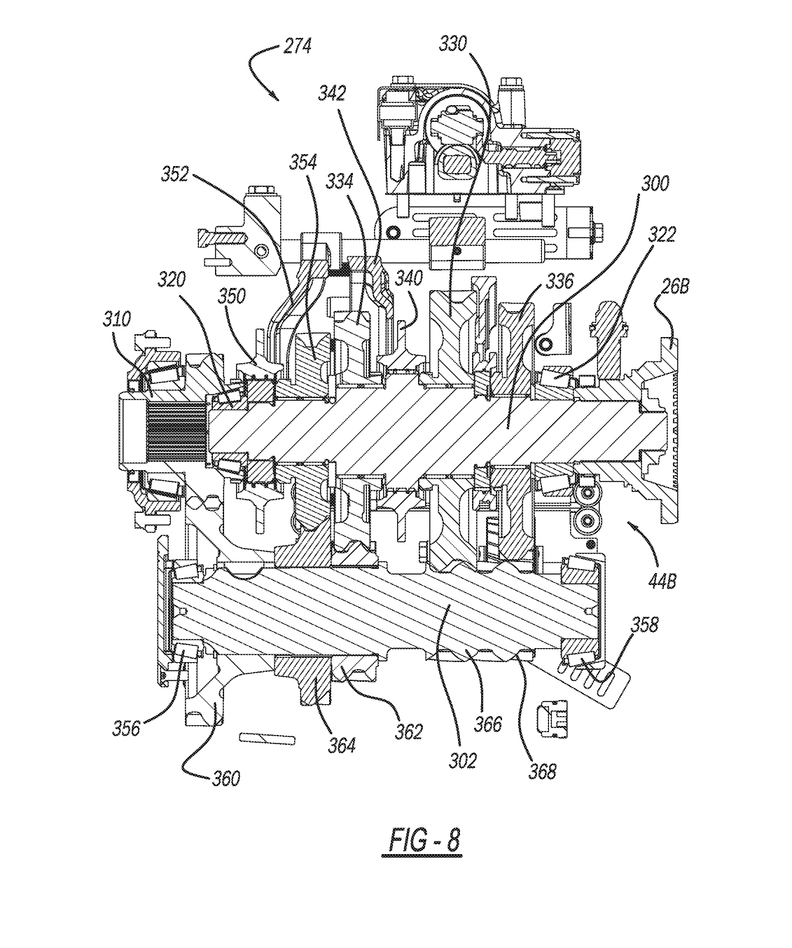

With reference to FIGS. 6-8, the rear housing 42B including the second gear set 44B will be described. A motor assembly 272 includes a first motor 272A and a second motor 272B that are arranged in an X-Y configuration and provide a shift input for a shift assembly 274 (FIG. 8). As identified above, the rear housing 42B can include a different gear set than the rear housing 42A to achieve different gear ratios and/or gear combinations. In the exemplary gear set 44B, a four speed transmission with reverse gear is provided.

The first gear set 44B includes a mainshaft 300 and a countershaft 302. In the example shown, the mainshaft 300 is coaxial with the transmission input shaft 22. The countershaft 302 is offset from the input shaft 22 and the mainshaft 300. The output shaft 26 may be coaxial with the mainshaft 300. The transmission input shaft 22 can be splined for rotation with an input gear 310. The mainshaft 300 is supported in the modular transmission 12B by a front mainshaft bearing 320 and a rear mainshaft bearing 322. The mainshaft 300 rotatably supports a mainshaft first gear 330, a mainshaft second gear 332, a mainshaft third gear 334, and a mainshaft reverse gear 336. A first/second sliding clutch 340 is actuated by a first/second shift yoke 342. A third/fourth sliding clutch 350 is actuated by a third/fourth shift yoke 352. The countershaft 302 is supported in the modular transmission 12B by a front countershaft bearing 356 and a rear countershaft bearing 358. The countershaft 302 rotatably supports a countershaft input gear 360, a countershaft second gear 362 and a countershaft third gear 364. Countershaft first gear teeth 366 are defined on the countershaft 302 for meshingly engaging the mainshaft first gear 330. Countershaft second (reverse) gear teeth 368 are defined on the countershaft 302 for meshingly engaging the mainshaft reverse gear 336. A wet sump 370 can be provided in the modular transmission 12B having adaptable oil level.

The transmission system assembly 10 of the present disclosure provides a solution for an extremely broad and under-defined CEV market. The transmission system assembly 10 is adaptable to a wide range of electric motors, vehicle chassis and vocations that require distinct gear ratios all while maintaining a simple low cost design which can be easily integrated into the powertrain system for a wide range of original equipment manufacturers. The housings 40, 42A, 42B accept larger or smaller gears with minimal to no design change, effectively changing the overall gear ratios. In some instances, the countershaft 102, 302 would require redesign to account for any gears cut thereon.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A modular transmission system selectively coupled to an electric motor arranged on a vehicle, the modular transmission system comprising:
a front housing having a transmission motor mount and at least one transmission chassis mount, the transmission motor mount configured to mount the front housing relative to the electric motor, the at least one transmission chassis mount configured to mount the front housing relative to a chassis of the vehicle;
a first rear housing having a first gear set, the first rear housing configured to selectively couple to the front housing to provide first gear ratios in the first modular transmission configuration; and
a second rear housing having a second gear set, the second rear housing configured to selectively couple to the front housing to provide second gear ratios in the second modular transmission configuration;
wherein the front housing is configured to selectively and alternatively accept (i) the first rear housing and first gear set for operation in a first modular transmission configuration and (ii) the second rear housing and second gear set for operation in a second modular transmission configuration.

2. The modular transmission system of claim 1 wherein the first gear set is configured as a four speed with no reverse gear and having a Y-Y shifting mechanism.

3. The modular transmission system of claim 1 wherein the first gear set is configured as a three speed with no reverse gear and having a Y-Y shifting mechanism.

4. The modular transmission system of claim 1 wherein the second gear set is configured as a four speed with reverse gear and having an X-Y shifting mechanism.

5. The modular transmission system of claim 1 wherein the second gear set is configured as a three speed with reverse gear and having a Y-Y shifting mechanism.

6. The modular transmission system of claim 1, further comprising an adapter plate that mounts between the electric motor and the front housing.

7. The modular transmission system of claim 6 wherein the transmission motor mount includes a transmission mounting plate configured to selectively mate with the electric motor in a first arrangement and the adapter plate in a second arrangement.

8. The modular transmission system of claim 1 wherein the first gear set includes:
a first input gear;
a first mainshaft that supports a mainshaft first gear, a mainshaft second gear, and a mainshaft third gear; and
a first countershaft that supports a countershaft input gear, a countershaft second gear and a countershaft third gear.

9. The modular transmission system of claim 1 wherein the second gear set includes:
a second input gear;
a second mainshaft that supports a mainshaft first gear, a mainshaft second gear, a mainshaft third gear, and a mainshaft reverse gear; and
a second countershaft that defines reverse gear teeth supports a countershaft input gear, a countershaft second gear and a countershaft third gear.

10. The modular transmission system of claim 2 wherein the Y-Y shifting mechanism includes a motor assembly including a first motor and a second motor configured to provide a shift input for a shift assembly having a first/second sliding clutch and a third/fourth sliding clutch.

11. The modular transmission system of claim 10 wherein the shifting mechanism further comprises a first/second shift yoke that actuates the first/second sliding clutch and a third/fourth shift yoke that actuates the third/fourth shift yoke.

12. The modular transmission system of claim 1 wherein the modular transmission system is configured as a wet sump.

13. The modular transmission system of claim 8, further comprising a cover plate removably coupled to the rear housing, the cover plate configured to be removed to access the first countershaft to provide a rotatable input for a power take-off device.

14. The modular transmission system of claim 1 wherein the front housing includes a front housing flange configured to selectively and alternatively align with (i) a first complementary flange on the first rear housing in the first modular transmission configuration and (ii) a second complementary flange on the second rear housing in the second modular transmission configuration.

15. The modular transmission system of claim 14, further comprising fasteners that locate through passages defined through the respective front housing flange and (i) first complementary flange in the first modular transmission configuration and (ii) second complementary flange in the second modular transmission configuration.

16. A modular transmission system selectively coupled to an electric motor arranged on a vehicle, the modular transmission system comprising:
a front housing having a transmission motor mount, and a front housing flange, the transmission motor mount configured to mount the front housing relative to the electric motor;
a first rear housing having a first gear set, the first rear housing configured to selectively couple to the front housing to provide first gear ratios in a first modular transmission configuration, the first gear ratios including at least three speeds, the first rear housing having a first complementary flange; and
a second rear housing having a second gear set, the second rear housing configured to selectively couple to the front housing to provide second gear ratios in a second modular transmission configuration, the second gear ratios including at least three speeds and a reverse gear, the first rear housing having a first complementary flange;
wherein the front housing flange is configured to selectively and alternatively mate with (i) the first complementary rear housing flange and first gear set for operation in the first modular transmission configuration and (ii) the second complementary rear housing flange and second gear set for operation in the second modular transmission configuration.

17. The modular transmission system of claim 16 wherein the first gear set includes:
a first input gear;
a first mainshaft that supports a mainshaft first gear, a mainshaft second gear, and a mainshaft third gear; and
a first countershaft that supports a countershaft input gear, a countershaft second gear and a countershaft third gear.

18. The modular transmission system of claim 17 wherein the second gear set includes:
a second input gear;
a second mainshaft that supports a mainshaft first gear, a mainshaft second gear, a mainshaft third gear, and a mainshaft reverse gear; and
a second countershaft that defines reverse gear teeth supports a countershaft input gear, a countershaft second gear and a countershaft third gear.

19. The modular transmission system of claim 16, further comprising an adapter plate that mounts between the electric motor and the front housing.

20. The modular transmission system of claim 19 wherein the front housing includes a transmission mounting plate configured to selectively mate with the electric motor in a first arrangement and the adapter plate in a second arrangement.
